(19) United States
(12) Patent Application Publication
(10) Pub. No.: US 2026/0109497 A1
(43) Pub. Date: Apr. 23, 2026

(54) System and Methods for Unmanned Aerial Vehicles (UAVs)

(71) Applicant: Liviu Grigorian GIURCA, Craiova (RO)

(72) Inventor: Liviu Grigorian GIURCA, Craiova (RO)

(21) Appl. No.: 18/772,835

(22) Filed: Jul. 15, 2024

(51) Int. Cl. B64U 70/30; B64U 10/20; B64U 10/25; B64U 20/80; B64U 50/19; B64U 50/37; B64U 80/25; B64U 80/84; B64U 80/86; B64U 101/64

(52) U.S. Cl. CPC B64U 70/30; B64U 10/20; B64U 10/25; B64U 20/80; B64U 50/19; B64U 50/37; B64U 80/25; B64U 80/84; B64U 80/86; B64U 2101/64; B64U 2201/10

(57) ABSTRACT

A propulsion system for an aerial vehicle includes a fuselage defining a central longitudinal axis, a nacelle defining a central axis, a front wing and a rear wing connected by the fuselage and extending perpendicularly from the central longitudinal axis to define a front axis and a rear axis, and a thruster assembly configured to generate an airflow. The nacelle is affixed to a middle portion of the fuselage. The front wing and the rear wing are parallel and spaced apart from each other along the central longitudinal axis. The thruster assembly includes a plurality of thrusters affixed to an arm extending from the fuselage, which are disposed between the front wing and the rear wing. Each thruster includes an electric motor and a propeller. A ring is affixed to a central area of a lower surface of the front wing, which has a central hole defined therein.

### TECHNICAL FIELD

The present disclosure relates to systems and methods for unmanned aerial vehicles (UAVs) and, more specifically, to unmanned aerial vehicles and associated aerial systems configured with vertical take-off and landing (VTOL) capabilities.

### BACKGROUND

Unmanned aerial vehicles (UAVs) may include drones designed for various missions. For example, UAVs can be divided into fixed-wing UAVs, multi-propeller (e.g., rotary-wing) UAVs, and mixed (e.g. hybrid) UAVs. Typically, mixed UAVs include multiple propellers and fixed wings combine the advantages of fixed-wing UAVs and multi-propeller UAVs.

Due to their heightened speed and energy efficiency, UAVs may be advantageous for delivering package. For example, because drones do not rely on roads for transportation, they may fly direct routes to destinations that avoid land traffic (e.g., avoids constantly slowing down and accelerating), thereby drastically reducing delivery times. Moreover, because UAVs are electric vehicles, they have zero CO2 emissions, soot particles, toxic gases, and/or rubber abrasion. Therefore, UAVs are more environmentally friendly compared to car delivery. Further, UAVs minimize costs for delivery companies as less personnel are needed For example, customers who own a private house with a yard may request that goods be delivered on flat land (e.g., a backyard), which similarly avoids highway traffic and tolls

However, modern UAVs often face limitations due to unmodifiable form and/or standardized modes of operation. For example, UAVs may be unable to deliver packages to customers located in multi-level apartments, which in many countries represent the majority of buildings. In addition, the number of executable missions for drones may be limited by the type of propulsion and/or the take-off/landing position.

Accordingly, there is a need for improved systems and methods for unmanned aerial vehicles, which include versatile forms and/or modes of transportation for various terrains

### SUMMARY

In accordance with aspects of the present disclosure, a propulsion system for an aerial vehicle includes a fuselage defining a central longitudinal axis, a nacelle defining a central axis, a front wing and a rear wing connected by the fuselage and extending perpendicularly from the central longitudinal axis to define a front axis and a rear axis, and a thruster assembly configured to generate an airflow. The nacelle is affixed to a middle portion of the fuselage. The front wing and the rear wing are parallel and spaced apart from each other along the central longitudinal axis. The thruster assembly includes a plurality of thrusters affixed to an arm extending from the fuselage, which are disposed between the front wing and the rear wing. Each thruster includes an electric motor and a propeller driven by the electric motor. A ring is affixed to a central area of a lower surface of the front wing, which has a central hole defined therein. The front wing and the rear wing each define a median profile chord and the central axis is substantially parallel to the median profile chord.

In an aspect of the present disclosure, the thruster assembly may include three pairs of thrusters supported by a plurality of arms extending symmetrically from the fuselage. The plurality of arms may be located in a middle portion of the aerial vehicle extend and can extend outwards at a length greater than arms located in a front portion and a rear portion of the aerial vehicle.

In another aspect of the present disclosure, the fuselage may have a lower, flat portion including a contact having curved, metallic plates; a battery configured to be charged through the contact; and a metal plate affixed thereto. The battery may be located in a stationary portion of the aerial vehicle.

In yet another aspect of the present disclosure, the nacelle may include an enclosure closed at a first end by an upper cover and at a second end by a lower cover. The upper cover and the lower cover may be operated automatically to charge the aerial vehicle in a stationary mode and to deliver a package in a flight mode.

In a further aspect of the present disclosure, the system may further include a flight control system configured to regulate a pitch angle of the aerial vehicle during flight. The flight control system may include a camera and/or a sensor affixed to the fuselage.

In yet a further aspect of the present disclosure, the system may further include a docking station configured as a base for take-off and landing. The docking station may include a wall having a panel integrated therein. The panel may include a hook configured to support the aerial vehicle, a contact configured to connect to a charging system of the battery of the aerial vehicle, and a metal plate configured to be magnetized by a coil.

In an aspect of the present disclosure, the aerial vehicle may be an unmanned aerial vehicle configured for autonomous flight.

In another aspect of the present disclosure, the docking station may be integrated into a window and/or a balcony of a building. The nacelle may be configured to store a package therein for delivery to an individual.

In yet another aspect of the present disclosure, a plurality of aerial vehicles may be configured to use the docking station simultaneously and integrate into a delivery system.

In a further aspect of the present disclosure, a plurality of aerial vehicles may be stationed on hooks affixed to an inclined wall of a terrestrial vehicle.

In yet a further of the present disclosure, a plurality of aerial vehicles may be stationed on hooks affixed to a vertically oriented wall of a boat.

In accordance with aspects of the present disclosure, a method of operating an aerial vehicle to transition between a vertical take-off and landing (VTOL) flight mode and a horizontal forward flight mode includes: in a first phase, activating an electric motor of the aerial vehicle, causing the aerial vehicle to take off from a horizontal surface and transition to vertical flight; in a second phase, transitioning the aerial vehicle from vertical flight to horizontal flight, causing a fuselage of the aerial vehicle pivots towards a front of the aerial vehicle; and in a third phase, transitioning the aerial vehicle from horizontal flight to horizontal forward flight, causing a front wing and a rear wing of the aerial vehicle to be positioned at an optimal angle of attack with a frontal air flow. The optimal angle of attack ranges from between 2 and 8 degrees.

In an aspect of the present disclosure, the method may further include transitioning the aerial vehicle between vertical flight and a stationary position on a vertical wall, including: in a fourth phase, descending the aerial vehicle vertically above a docking station using at least one of a camera or a plurality of sensors, orienting the fuselage is in a horizontal position; in a fifth phase, connecting a ring of the aerial vehicle to a hook of the docking station; in a sixth phase, tilting the fuselage backwards; and in a seventh phase, orienting the fuselage in a vertical position corresponding to the stationary position.

In another aspect of the present disclosure, in the stationary position, contacts of the aerial vehicle may overlap with contacts of a panel in the docking station, recharging a battery of the aerial vehicle.

In another aspect of the present disclosure, in the stationary position, a metal plate of the aerial vehicle may overlap a metal plate of the panel, magnetizing the metal plate of the panel and fixing the aerial vehicle in the vertical position.

In yet another aspect of the present disclosure, the method may further include: demagnetizing the metal plate of the docking station; and releasing the aerial vehicle from the docking station, causing the aerial vehicle to take off.

In a further aspect of the present disclosure, positional changes of the fuselage may be caused by a differential adjustment of propellers on a rear portion and a front portion of the aerial vehicle using different rotational speeds of corresponding electric motors.

In yet a further aspect of the present disclosure, a package may be delivered by the aerial vehicle in a horizontal landing position and/or in a vertical landing position.

In an aspect of the present disclosure, the aerial vehicle may be an unmanned aerial vehicle configured for autonomous flight.

In accordance with aspects of the present disclosure, a propulsion system for an unmanned aerial vehicle (UAV) may include a fuselage defining a central longitudinal axis, a nacelle defining a central axis, a front wing and a rear wing connected by the fuselage and extending perpendicularly from the central longitudinal axis to define a front axis and a rear axis, and a thruster assembly configured to generate an airflow. The nacelle is affixed to a middle portion of the fuselage. The front wing and the rear wing are parallel and spaced apart from each other along the central longitudinal axis. The thruster assembly includes three pairs of thrusters supported by a plurality of arms extending symmetrically from the fuselage. The plurality of arms are located in a middle portion of the UAV between the front wing and the rear wing and extend outwards at a length greater than arms located in a front portion and a rear portion of the UAV. Each thruster includes an electric motor and a propeller driven by the electric motor. A ring is affixed to a central area of a lower surface of the front wing and the ring has a central hole The front wing and the rear wing each define a median profile chord and the central axis is substantially parallel to the median profile chord.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying figures of which:

FIG. 1 is a side, perspective view of an unmanned aerial vehicle (UAV) system, in accordance with aspects of the present disclosure;

FIG. 2 is a side view of the UAV system of FIG. 1, in accordance with aspects of the present disclosure;

FIG. 3 is a bottom perspective view of the UAV system of FIG. 1, in accordance with aspects of the present disclosure;

FIG. 4 is a rear area of a fuselage of the UAV system of FIG. 1, in accordance with aspects of the present disclosure;

FIG. 5 is a perspective view of the UAV system of FIG. 1 in a first phase, in accordance with aspects of the present disclosure;

FIG. 6 is a perspective view of the UAV system of FIG. 1 in a second phase, in accordance with aspects of the present disclosure;

FIG. 7 is a perspective view of the UAV system of FIG. 1 in a third phase, in accordance with aspects of the present disclosure;

FIG. 8 is a perspective view of the UAV system of FIG. 1 in a first phase, in accordance with aspects of the present disclosure;

FIG. 9 is a perspective view of the UAV system of FIG. 1 in a second phase, in accordance with aspects of the present disclosure;

FIG. 10 is a perspective view of the UAV system of FIG. 1 in a third phase, in accordance with aspects of the present disclosure;

FIG. 11 is a perspective view of the UAV system of FIG. 1 in a fourth phase, in accordance with aspects of the present disclosure;

FIG. 12 is a use case of the UAV system of FIG. 1 in an aerial system, in accordance with aspects of the present disclosure; and

FIG. 13 is a use case of the UAV system of FIG. 1 in another aerial system, in accordance with aspects of the present disclosure;

### DETAILED DESCRIPTION

The present disclosure relates to systems and methods for unmanned aerial vehicles (UAVs) and, more specifically, to unmanned aerial vehicles and associated aerial systems configured with vertical take-off and landing (VTOL) capabilities. The UAV systems may be configured to transition from a vertical take-off mode to a horizontal flight mode and/or from a horizontal flight mode to a vertical landing mode using a number of fixed, thrust-producing elements. Take-off and landing positions of the UAV may also both be horizontal.

An advantage of the present disclosure is efficiency in UAV operation, offering versatile UAV usage regardless of the position in space of the landing surface. By utilizing dedicated aerial systems, the UAVs can take off from and/or land on inclined and vertical surfaces, offering safe and versatile operation. In aspects, the UAVs may be used for aerial delivery, aerial surveillance, advanced research systems for military personnel, and/or defensive aerial systems. For example, an aerial transport system may use the UAVs for direct and easy transport to various floors of apartments buildings, avoiding traditionally high costs and time consumption while providing safe, flexible delivery of packages. For example, delivery to a window or balcony may permit expedited package delivery. These same UAVs may further be used for delivery on flat land. In aspects, the UAVs may use vertical docking stations on the ground that are compact and facilitate staff access for loading packages.

Another advantage of the present disclosure is the ability to use the same UAV configuration for various types of aerial systems, with extensive applications in the civil and/or military fields. For example, the UAV systems and methods herein may be used for both short-range and long-range missions. In aspects, for defense missions, multiple UAVs may be carried in a substantially vertical position on a protected or armored terrestrial and/or naval launch vehicle, which nay house navigational personnel and/or operating terminals.

As used herein, a “UAV” refers to an aircraft that operates without a human pilot on board. UAVs may include nano/micro UAVs, mini UAVs, tactical UAVs, Medium Altitude Long Endurance (MALE) UAVs, High Altitude Long Endurance (HALE) UAVs, and/or combat UAVS, among others which vary based on design aspects. For example, UAVs may be fixed-wing UAVs, which resemble traditional airplanes with wings. Additionally, rotary-wing UAVs may include helicopters and multi-rotor designs (e.g., quadcopters, hexacopters, etc.) with vertical take-off and landing (VTOL) capabilities. Further, hybrid UAVs may combine features of fixed-wing and rotary-wing UAVs.

UAVs may be controlled either autonomously by onboard computers (e.g., controlled using artificial intelligence) or by remote controls from a ground-based operator. While disclosed herein for use with delivery and defense, UAVs may have a wide range of applications and such cases are merely exemplary. For example, UAVs may be used for: military operations including surveillance, reconnaissance, and/or combat mission; commercial purposes including delivery services, agricultural monitoring, infrastructure inspection, and/or aerial monitoring; recreational activities including flying and aerial photography; emergency services including search and rescue operations, disaster response, and/or firefighting; and environmental monitoring including wildlife tracking, environmental conservation, and/or pollution monitoring.

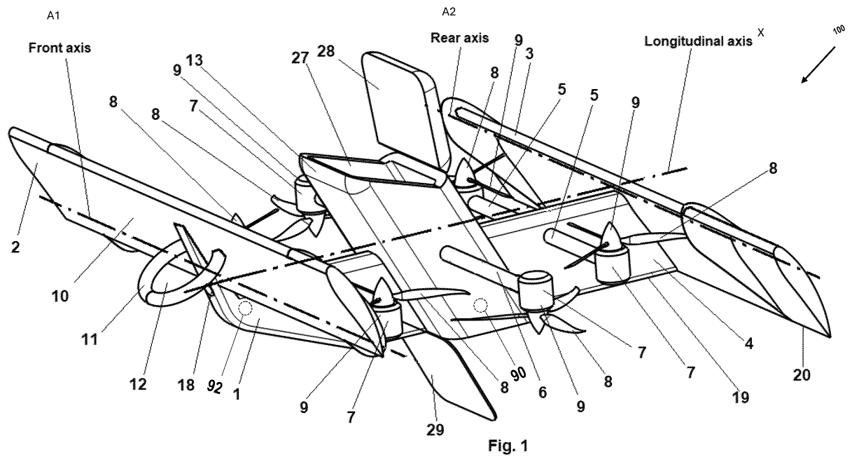

Referring to FIG. 1-4, a UAV system 100 with vertical take-off and landing is shown. The UAV system 100 may include a UAV 1 having a front section, a middle section, and/or a rear section. UAV 1 includes a fuselage 4 defining a central longitudinal axis X of the UAV system 100. The fuselage 4 connects a front wing 2 and a rear wing 3, which may both extend perpendicularly to the central longitudinal axis X, defining in a front axis A1 and a rear axis A2. The front wing 2 and rear wing 3 are generally parallel and spaced apart from one another along the central longitudinal axis X. In aspects, the front wing 2 and rear wing 3 each have a median profile chord. In aspects, the front wing 2 and the rear wing 3 are diametrically opposed wings. Between front wing 2 and rear wing 3, thruster assemblies 9 are fixed on the fuselage 4. The thruster assemblies 9 may be supported by arms 5 and 6 extending symmetrically from the fuselage 4. In aspects, arms 6 are more extended than arms 5, e.g., extend further in an outward direction away from fuselage 4. Each thrust assembly 9 includes at least one electric motor 7 and at least one propeller 8 (e.g., a thruster) powered by the electric motor 7. In aspects, the electric motor 7 may be powered by the battery 94.

The propeller 8 may include multiple propellers arranged symmetrically along the longitudinal axis X. In aspects, the propellers 8 may include front propellers disposed on a front portion of the fuselage 4, middle propellers disposed on a middle portion of the fuselage 4, and/or rear propellers disposed on a rear portion of the fuselage 4. While three pairs of thruster assemblies 9 are shown, various numbers, arrangements, and/or configurations of thruster assemblies 9 are contemplated and within the scope of this disclosure.

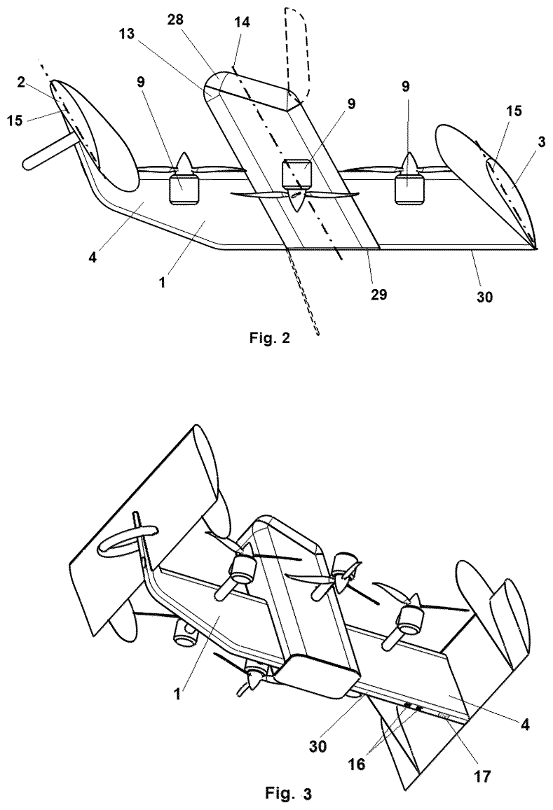

On the front wing 2, a ring 11 having a central hole 12 may be fixed thereto. In aspects, the ring 11 may be fixed on a central area of a lower surface 10 of the front wing 2, as show in FIG. 1. In the middle and/or median portion of the fuselage 4, a nacelle 13 may be fixed thereto, defining a central axis 14. The central axis may be parallel or substantially parallel to the median profile chords of the front wing 2 and the rear wing 3. The nacelle 13 may include nacelle covers, (e.g., two nacelle covers), which may be in an open position (FIG. 1) or a closed position (FIG. 2). The front wings 2 and the rear wings 3 each have a median chord 15 of their profile. The central axis 14 of the nacelle 13 and the median chords 15 are substantially parallel.

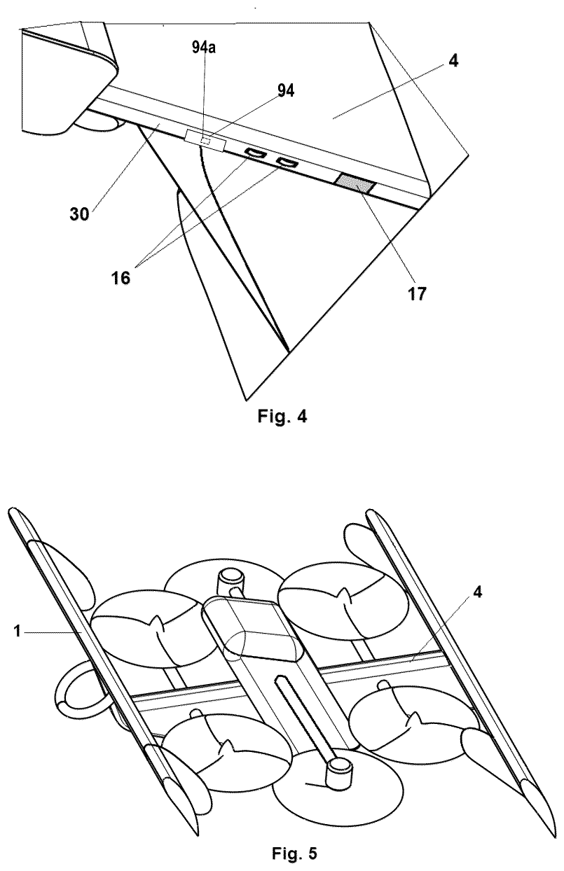

A flight control system 90 regulates the pitch angle, i.e., the longitudinal inclination, of the UAV system 100. At a lower part 30 of the fuselage 4, two contacts 16 are mounted in the form of curved, metallic plates, through which a battery 94 can be charged in a stationary period of the UAV system 100. The battery 94 serves to supply the electric motors 7 with energy during flight phases. The battery 94 may be a hybrid energy source and/or a battery pack. In aspects, an alternative power source may be used to charge the UAV system 100. A metal plate 17, made preferably of a ferro-magnetic material, is mounted on the lower portion of the fuselage 4 as shown in FIGS. 3 and 4. A camera 18 and sensors 92 are affixed to the front portion of the fuselage 4. Other cameras can be placed in other locations on the UAV system 100, e.g., on the fuselage 4, front wing 2, and rear wing 3. The nacelle 13 contains an enclosure 27 which is closed at a first end by an upper cover 28 and at a second end by a lower cover 29. Both upper and lower covers 28 and 29 can be operated automatically to charge and deliver a package during flight and stationary operations.

UAV system 100 can take off and land from substantially horizontal surfaces. For example, UAV system 100 may take off from a resting position on the ground, with a lower part 19 of the fuselage 4 including a trailing edge 20 of the rear wing 3. In aspects, UAV system 100 can take-off and land from a docking station 21 on a wall 22, having a vertical or slightly inclined position, as shown in FIGS. 8-10. In aspects, wall 22 includes an integrated panel 26. A hook 23 may be fixed on panel 26. Two contacts 24 are fixed on panel 26, which may connect to a charging system 94a of the battery. A metal plate 25 may be fixed below the two contacts 24 on the panel 26, which can be magnetized and/or demagnetized by a coil 25a.

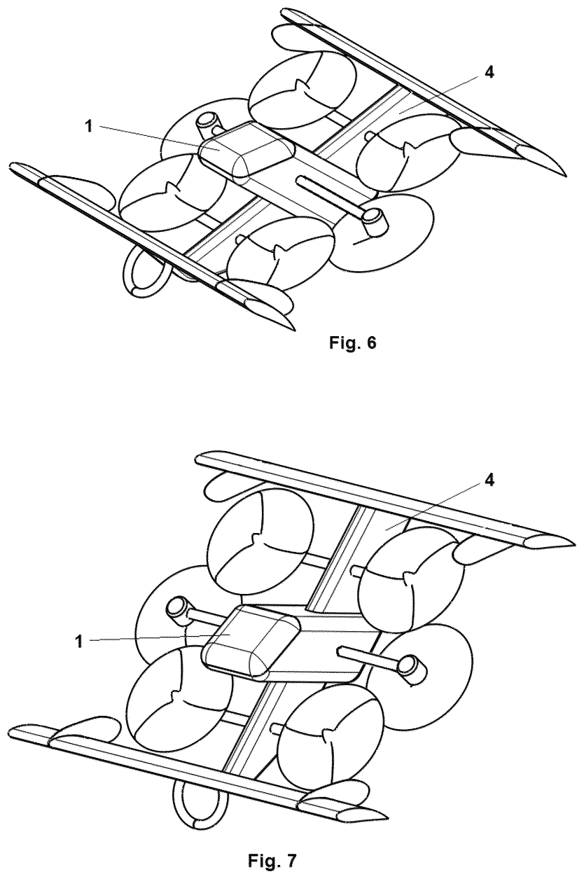

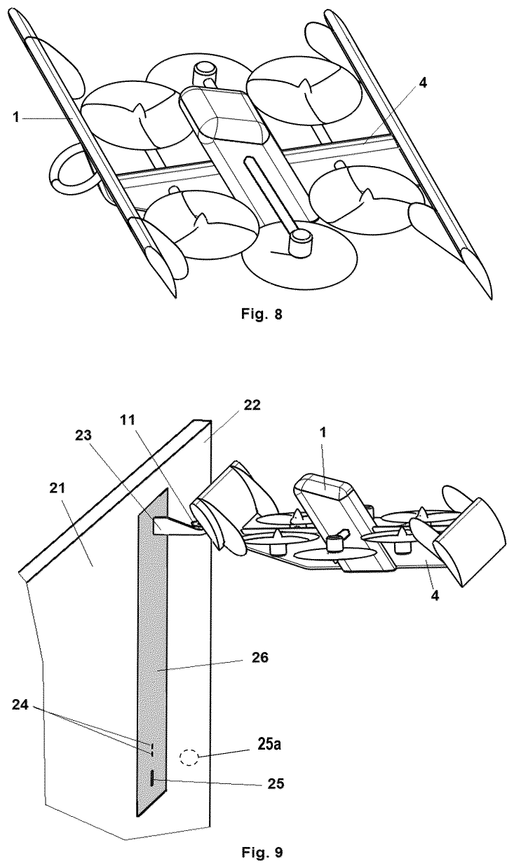

Now referring to FIG. 5-7, the UAV system 100 is operable to transition between a vertical take-off and landing flight mode and a horizontal forward flight mode, and vice versa. In a first phase when electric motors 7 are turned on (e.g., a take-off horizontal phase), the UAV system 100 takes off from a horizontal surface, as shown in FIG. 5. In a second phase (e.g., a transition phase), the transition from vertical to horizontal flight takes place. In doing so, the fuselage 4 begins to pivot towards the front (e.g., the front of the UAV system 100, the front of the UAV, or the front of the aerial vehicle generally), as shown in FIG. 6. In a third phase (e.g., a horizontal forward flight phase), during the transition to horizontal forward flight, the front wing 3 and rear wing 4 reach an optimal angle of attack with the frontal air flow (e.g., parallel with the front air flow), as shown in FIG. 7. The optimal angle of attack may range between 2-8 degrees relative to the longitudinal axis X, front axis, A1, and/or rear axis A2.

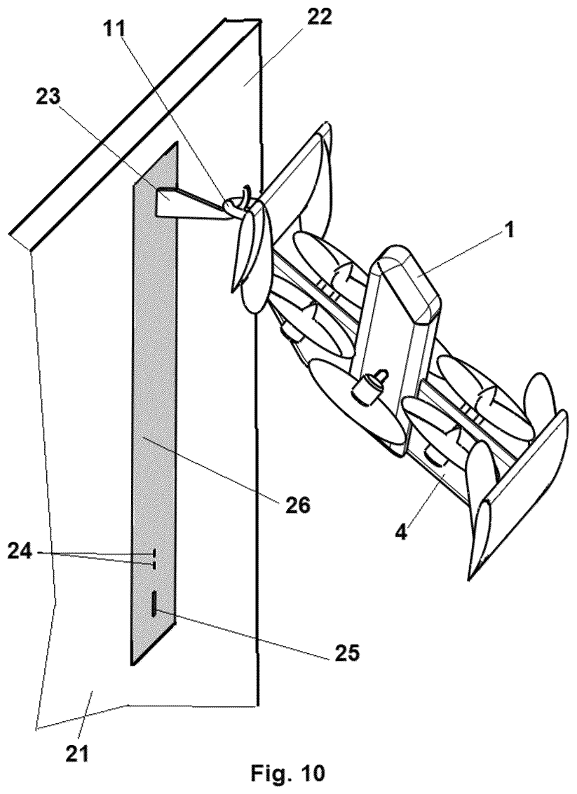

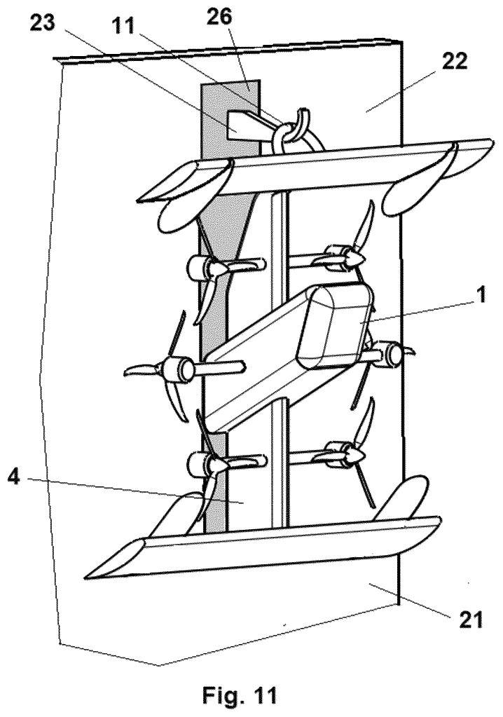

Now referring to FIG. 8-11, the UAV system 100 is operable to transition between a vertical flight mode (FIG. 8) and a stationary mode on a vertical wall 22 (FIG. 11). In a first phase (e.g., in a hover and/or vertical descend phase, approaching the docking station 21), the UAV system 100 descends vertically above the docking station 21 with the help of the camera 18 and the existent proximity seasons, such that the fuselage 4 is in a horizontal position, as shown in FIG. 8. In a second phase, (e.g., a securement phase, grasping the docking station 21) the ring 11 catches the hook 23 of the docking station 21, as shown in FIG. 9. In a third phase (e.g., a transition phase), the UAV system 100 tilts the fuselage 4 backwards during the transition from vertical flight to the stationary phase, as shown in FIG. 10. In a fourth operating phase (e.g., a stationary phase), the UAV system 100 arrives with the fuselage 4 in a vertical position, which consequently corresponds to a stationary position, as shown in FIG. 11. In aspects, some or all of the phases may be performed and/or combined with the first, second, and third phases disclosed in FIG. 5-7, e.g., a method for transitioning between a vertical take-off and landing flight mode and a horizontal forward flight mode, and vice-versa. Thus, the first phase may be a fourth phase, the second phase may be a fifth phase, etc.

In the stationary phase, the contacts 16 of the UAV system 100 overlap the contacts 24 of the panel 26 and the battery of the UAV system 100 is recharged. The metal plate 17 of the UAV system 100 overlaps the metal plate 25 of panel 26, which may be magnetized and/or fix the UAV system 100 in the vertical position. To take off from the docking station 21, the metal plate 25 of the docking station 21 is demagnetized, the UAV system 100 is released, and the aforementioned process is reversed. In all phases of operation, the positional changes of the fuselage 4 are made by a differential adjustment of the propellers 8 from the back side compared to the propellers 8 from the front side of the UAV system 100 (and vice versa), by using different rotation speeds of the corresponding electric motors 7. In aspects, several UAVs 1 can simultaneously use the same docking station 21.

The docking station 21 and the UAVs 1 may be integrated into a delivery system for packages and/or equipment, which can be loaded and transported in the nacelle 13. By using the vertical position to take off and land each UAV system 100 on the docking station 21, the space on the ground of the delivery system can be reduced. Further, the packages can easily be handled and/or inserted into the nacelle 13 by the service personnel. In addition, once they arrive at their destination, the packages can be delivered by each UAV system 100 both in the horizontal l landing position and in the vertical landing position. In aspects, the panel 26 can be integrated into a building, e.g., near a window or a balcony from which the customer can easily take over the package located inside the nacelle 13. The UAVs 1 may be commanded by a regional operation center.

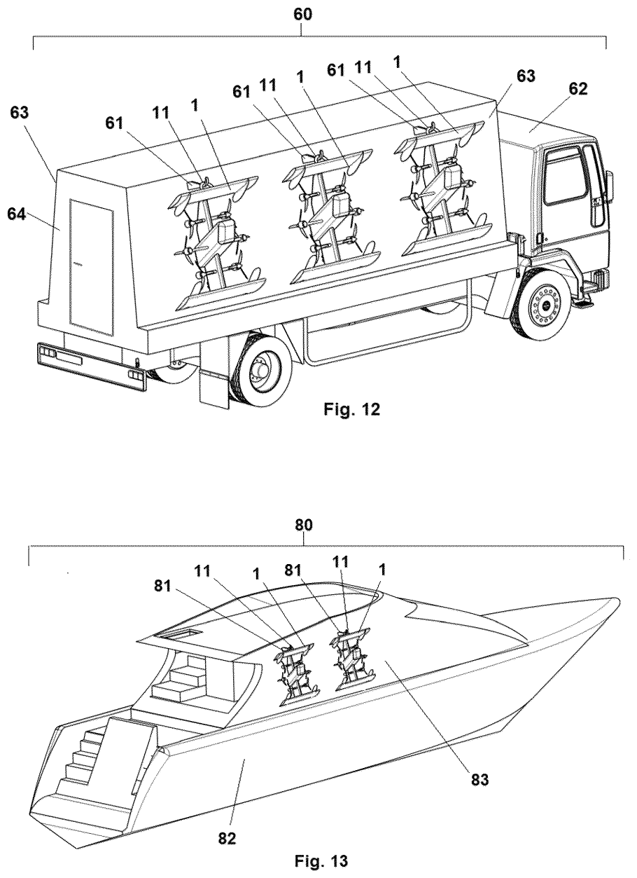

Now referring to FIGS. 12 and 13, aerial systems 60 and 80 are shown, which have various use cases. For example, aerial system 60 (FIG. 12) may be a defensive system that uses UAV system 100 and/or several stationed UAVs 1. The UAV system 100 and/or UAVs 1 may be docked on docking stations including several hooks 61 and/or fixed on a terrestrial vehicle 62. The hooks 61 are positioned on at least one inclined or vertically oriented wall 63 of the vehicle 62. Between the two walls 63, a base station 64 provides functions for planning, executing, and/or analyzing missions (e.g., for command and control operations). All data of the missions are stored on the base station 64 for coordination, review, and/or sharing. In another example, aerial system 80 (FIG. 13) may be a naval system using several UAVs 1 and/or UAV system 100 including docking stations and/or attached to hooks 81 fixed on a boat 82, such as a naval carrier ship. The hooks 81 are positioned on at least one vertically oriented wall 83 of the boat 82. Using aerial systems 60 and 80, the UAVs 1 can operate together to perform a common action or mission.

Certain aspects of the present disclosure may include some, all, or none of the above advantages and/or one or more other advantages readily apparent to those skilled in the art from the figures, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached figures are presented only to demonstrate certain examples of the disclosure. Other elements, steps, methods, and techniques that are insubstantially different from those described above and/or in the appended claims are also intended to be within the scope of the disclosure.

What is claimed is:

1. A propulsion system for an aerial vehicle, including:
a fuselage defining a central longitudinal axis;
a nacelle defining a central axis and affixed to a middle portion of the fuselage;
a front wing and a rear wing connected by the fuselage and extending perpendicularly from the central longitudinal axis to define a front axis and a rear axis, respectively, wherein the front wing and the rear wing are parallel and spaced apart from each other along the central longitudinal axis; and
a thruster assembly configured to generate an airflow and including a plurality of thrusters affixed to at least one arm extending from the fuselage, the plurality of thrusters disposed between the front wing and the rear wing, wherein each thruster includes at least one electric motor and at least one propeller driven by the electric motor,
wherein a ring is affixed to a central area of a lower surface of the front wing, the ring having a central hole defined therein, and
wherein the front wing and the rear wing each define a median profile chord, the central axis being substantially parallel to at least one median profile chord.

2. The system of claim 1, wherein the thruster assembly includes three pairs of thrusters supported by a plurality of arms extending symmetrically from the fuselage, the plurality of arms located in a middle portion of the aerial vehicle,
wherein the plurality of arms extend outwards at a length greater than arms located in a front portion and a rear portion of the aerial vehicle.

3. The system of claim 1, wherein the fuselage has lower, flat portion including:
at least one contact having curved, metallic plates;
a battery configured to be charged through the at least one contact, the battery located in a stationary portion of the aerial vehicle; and
a metal plate affixed thereto.

4. The system of claim 1, wherein the nacelle includes an enclosure closed at a first end by an upper cover and at a second end by a lower cover, wherein the upper cover and the lower cover may be operated automatically to charge the aerial vehicle in a stationary mode and to deliver a package in a flight mode.

5. The system of the claim 1, further comprising a flight control system configured to regulate a pitch angle of the aerial vehicle during flight, wherein the flight control system includes at least one of a camera or a sensor affixed to the fuselage.

6. The system of claim 3, further comprising a docking station configured as a base for take-off and landing, the docking station including a wall having a panel integrated therein, wherein the panel includes:
a hook configured to support the aerial vehicle;
at least one contact configured to connect to a charging system of the battery of the aerial vehicle; and
a metal plate configured to be magnetized by a coil.

7. The system of claim 1, wherein the aerial vehicle is an unmanned aerial vehicle configured for autonomous flight.

8. The system of the claim 6, wherein the docking station is integrated into at least one of a window or a balcony of a building, and wherein the nacelle configured to store a package therein for delivery to an individual.

9. The system of the claim 6, wherein a plurality of aerial vehicles are configured to use the docking station simultaneously and integrate into a delivery system.

10. The system of the claim 1, wherein a plurality of aerial vehicles are stationed on hooks affixed to at least one inclined wall of a terrestrial vehicle.

11. The system of the claim 1, wherein a plurality of aerial vehicles are stationed on hooks affixed to at least one vertically oriented wall of a boat.

12. A method of operating an aerial vehicle to transition between a vertical take-off and landing (VTOL) flight mode and a horizontal forward flight mode, the method comprising:
in a first phase, activating at least one electric motor of the aerial vehicle, wherein activating the at least one electric motor causes the aerial vehicle to take off from a horizontal surface and transition to vertical flight;
in a second phase, transitioning the aerial vehicle from vertical flight to horizontal flight, wherein a fuselage of the aerial vehicle pivots towards a front of the aerial vehicle; and
in a third phase, transitioning the aerial vehicle from horizontal flight to horizontal forward flight, wherein a front wing and a rear wing of the aerial vehicle are each positioned at an optimal angle of attack with a frontal air flow, the optimal angle of attack ranging from between 2 and 8 degrees.

13. The method of claim 12, further comprising transitioning the aerial vehicle between vertical flight and a stationary position on a vertical wall, including:
in a fourth phase, descending the aerial vehicle vertically above a docking station using at least one of a camera or a plurality of sensors, wherein the fuselage is in a horizontal position;
in a fifth phase, connecting a ring of the aerial vehicle to a hook of the docking station;
in a sixth phase, tilting the fuselage backwards; and
in a seventh phase, orienting the fuselage in a vertical position corresponding to the stationary position.

14. The method of claim 13, wherein in the stationary position, contacts of the aerial vehicle overlap with contacts of a panel in the docking station, recharging a battery of the aerial vehicle.

15. The method of claim 14, wherein in the stationary position, a metal plate of the aerial vehicle overlaps a metal plate of the panel, magnetizing the metal plate of the panel and fixing the aerial vehicle in the vertical position.

16. The method of claim 15, further comprising:
demagnetizing the metal plate of the docking station; and
releasing the aerial vehicle from the docking station, causing the aerial vehicle to take off.

17. The method of claim 13, wherein positional changes of the fuselage are caused by a differential adjustment of propellers on a rear portion and a front portion of the aerial vehicle using different rotational speeds of corresponding electric motors.

18. The method of claim 13, wherein packages are delivered by the aerial vehicle in at least one of a horizontal landing positions or a vertical landing positions.

19. The method of claim 12, wherein the aerial vehicle is an unmanned aerial vehicle configured for autonomous flight.

20. A propulsion system for an unmanned aerial vehicle (UAV), including:
a fuselage defining a central longitudinal axis;
a nacelle defining a central axis and affixed to a middle portion of the fuselage;
a front wing and a rear wing connected by the fuselage and extending perpendicularly from the central longitudinal axis to define a front axis and a rear axis, respectively, wherein the front wing and the rear wing are parallel and spaced apart from each other along the central longitudinal axis; and
a thruster assembly configured to generate an airflow and including three pairs of thrusters supported by a plurality of arms extending symmetrically from the fuselage, the plurality of arms located in a middle portion of the UAV between the front wing and the rear wing, wherein the plurality of arms extend outwards at a length greater than arms located in a front portion and a rear portion of the UAV, and wherein each thruster includes at least one electric motor and at least one propeller driven by the electric motor,
wherein a ring is affixed to a central area of a lower surface of the front wing, the ring having a central hole defined therein, and
wherein the front wing and the rear wing each define a median profile chord, the central axis being substantially parallel to at least one median profile chord.
